(19) United States
(12) Patent Application Publication
(10) Pub. No.: US 2002/0102393 A1
(43) Pub. Date: Aug. 1, 2002

(54) Decorative iridescent film

(75) Inventor: Daniel J. Graney, LeGrangeville, NY (US)

Correspondence Address: Edward A Meilman Esq, Dickstein Shapiro Morin & Oshinsky LLP, 1177 Avenue of the Americas, 41st Floor, New York, NY, 10036-2714, US

(73) Assignee: Engelhard Corp.

(21) Appl. No.: 09/774,492

(22) Filed: Jan. 31, 2001

(51) Int. Cl. B32B 7/02

(52) U.S. Cl. 428/212; 428/195; 428/332

(57) ABSTRACT

A method of producing a multilayer co-extruded iridescent film of sufficient strength to be slit into microfilaments includes orientating a multilayer co-extruded iridescent film of at least 10 generally parallel very thin layers of substantially uniform thickness, the contiguous adjacent layers being of different thermoplastic resinous materials whose refractive index differ by at least about 0.03 until the thickness of the film is about 20% and 50% of the film before orientation.

### BACKGROUND OF THE INVENTION

Multilayer co-extruded light-reflecting films which have a narrow reflection band due to light interference are known. When that reflection band occurs in the range of visible wavelengths, the film appears iridescent.

The multilayer co-extruded iridescent films are composed of a plurality of generally parallel layers of transparent thermoplastic resinous material in which the contiguous adjacent layers are of diverse resinous material whose index of refraction differs by at least about 0.03. The film contains at least 10 layers and more usually at least 35 layers and preferably at least 70 layers.

The individual layers of the iridescent film are very thin, usually in the range of about 30-500 nm. The outermost layers can be thicker and form a skin on the remaining layers which constitute the optical core. The thicker skin layers may be one of the components which makes up the optical core or may be a different polymer which is utilized to impart desirable mechanical, heat sealing or other properties.

The quality of the iridescent multilayer co-extruded film is dependent on the individual layers being generally parallel and being of substantially uniform thickness and deviations therefrom interfere with the desired optical effect.

Examination of prior art iridescent films of desirable optical properties revealed deficiencies in certain mechanical properties. Most particularly, the adhesion between the individual layers of the multilayer structure could be insufficient and the film suffered from internal delamination of or separation of the layers during use. These films are often adhered to paper or board for their decorative effect and then used for greeting cards, cartons, wrapping paper and the like. The lamination of the film is unsightly and could lead to separation of glue joints of cartons. Efforts were therefore made to overcome these problems. U.S. Pat. No. 4,310,584 describes the use of thermoplastic terephthalate polyester or co-polyester resins as the component of one of the two adjacent polymer films. Another improvement is described in U.S. Pat. No. 5,089,318 in which a thermoplastic elastomer is employed as one of the resinous materials.

Despite the improvements which have been made in the iridescent co-extruded multilayer film, these films still have inadequate mechanical properties when compared to other film structures, in particular when compared to oriented films of similar polymer composition. These mechanical properties limit the use of the iridescent film in those applications where the inherent film strength is important. When employed for applications where greater mechanical properties are required, the iridescent film is laminated to a relatively strong clear film such as polyethylene terephthalate. This enables the composite material to be converted by printing, slitting, coating and the like within the normal operating parameters of the equipment conventionally used for such purposes.

A specific example of the foregoing is the use of iridescent film as decorative thread. In order to achieve a satisfactory material, it is necessary that a polyester or similar polymer film be affixed to at least one surface of the iridescent material, typically by laminating. The polyester or other material imparts satisfactory mechanical strength for the desired use but at the same time it also detracts from the aesthetics of the finished thread filaments. In addition, the laminated thread films are bulky and they do not provide a cloth-like feel when in contact with human skin. Therefore, a need still exists for a high strength iridescent film which can be converted by slitting into microfilaments without breaking and which retains substantially its original thickness for tactile quality. It also would be advantageous for the resulting film to have a preferential tear properties to promote the slitting of fine extrusive threads.

It is therefore the object of the invention to provide a high strength iridescent film which can be slit into microfilaments without breaking and which provides desirable tactile qualities.

This and other objects of the invention will become apparent to those of ordinary skill in the art from the following detailed description.

### SUMMARY OF THE INVENTION

This invention relates to a high strength iridescent multilayer co-extruded film and the method for its production. More particularly, provided is an iridescent multilayer co-extruded film formed by processing the iridescent film to impart orientation and to produce a final sheet of reduced thickness and improved mechanical strength.

### DESCRIPTION OF THE INVENTION

In accordance with the present invention, an iridescent multilayer co-extruded film is orientated, for instance, by being passed between rollers with the aid of a lubricant. In the course of this procedure, the iridescent film is compressed and uniaxially oriented. Since the iridescent appearance of the film is dependent on the uniformity of the layers and the film is usually co-extruded in widths exceeding 100 mm, it was quite surprising that the iridescent nature of the film could be retained while imparting sufficient strength in order to allow the film to be slit into microfilaments without breaking. In the past, it was necessary to laminate or otherwise combine the film with a support in order to achieve sufficient strength to permit the film to be microsplit into threads having a width on the order of about 0.15-0.30 mm and preferably about 0.25 mm.

The multilayer co-extruded iridescent film per se are known in the art. They are described in U.S. Pat. No. Re 31,780 to Cooper, Shetty and Pinsky, and U.S. Pat. Nos. 5,089,318 and 5,451,449, both to Shetty and Cooper, all of which are incorporated herein by reference, and in other patents. The iridescent film is, as there described, a transparent thermoplastic resinous laminated film of at least 10 very thin layers, usually in the range of about 30-500 nm and preferably about 50-400 nm, with the layers being generally parallel and the contiguous adjacent layers being of different transparent thermoplastic resinous materials differing in a refractive index by at least about 0.03 and preferably at least about 0.06. The outermost layers of the film constituting a skin, when present, are at least about 5% of the total thickness of the film each. For preparation of the film of the present invention, the film is initially thicker than desired since that thickness will be reduced by the compression or stretching. In general, the thickness after compression is about 20-50% of the thickness before compression, and preferable about 33-40%. For example, a film having a thickness of about 0.018 mm (0.7 mils) has been employed to make thread products in the past, and the film after lamination became 0.027 to 0.036 mm (1.1 to 1.4 mils). This is generally considered too thick for many textile applications, particularly where the filaments contact the skin. The film before compression in the instant invention will be about 0.038 to 0.064 mm (about 1.5 to 2.5 mils). The compression is usually such that the ultimate tensile (Instron) at break is in the range of about 5-20 lbf (about 2.9-9 kgf), and preferably about 10-15 lbf (about 4.5-7 kg).

The basic process of conventional orientation is well known. In order to achieve the required film properties, the film is stretched by a tension applied in the required direction. The stretching may occur between the cooling roll and the take up unit, with tension applied by draw rolls or by a combination of draw rolls. During the drawing process, the film is heated to temperatures below the crystalline melting point of the relevant raw material by roll contact and/or air (in the case of biaxially stretched film). The final dimension and temperatures employed are dictated by the target properties of the film.

The process of the compression rolling is known per se. It is described, for example, in U.S. Pat. Nos. 3,194,893 and 3,503,843, the disclosures of which are incorporated herein by reference. Briefly, the multilayer film is passed between rollers positioned so as to decrease the thickness to about 20 to 50% of its original thickness. A lubricant is used on the film as it passes through the nip between the two rollers. This can be applied either directly to the surface of the film or on the roller surface(s) so it is transferred to the surface of the film as it passes between the rollers. The processing temperature of the pressure rollers depends on the particular iridescent sheet being processed. In most instances, the temperature will be ambient but it can be varied from about 80 to 110° C.

The lubricant employed is any liquid or material which acts as a liquid in the area where the pressure from the rolls is applied to the film. The lubricant in this case acts to form a full or partial fluid film between the roll and the film so that the roll surface and the film surface are separated by the liquid lubricant thereby preventing contact and increasing mobility as the laminate enters the nip. Water can be used as the lubricant and it is often desirable to include a surfactant within the water.

In order to illustrate the present invention, various examples are given below. In these, all parts and percentages are by weight and all temperatures in ° C. unless otherwise specified.

In the following examples, film samples were produced with optical cores containing approximately 100 alternating layers in dimensions suitable for subsequent stretching to predetermined thickness. The standard thickness of these film categories range from 0.012-0.025 mm with peak reflected wavelength in the 460-580 nm range, depending on the color target for a particular application. The samples were produced in thicknesses ranging from 0.035 to 0.070 mm and exhibited virtually no reflected color.

### EXAMPLE 1

Sample 1 consisted of polybutylene terephthalate and polymethyl methacrylate, and sample 2 of polyethylene naphthalate and polybutylene terephthalate. The surface layer of both samples was polybutylene terephthalate.

The samples were processed using two-stage Marshall-Williams equipment and stretched at various orientation temperatures. Effective draw ratios varied from 1.8 to 2.6:1 at temperatures ranging from 110 to 145° C. At the predetermined ultimate gauge, color measurements were taken across the web to determine the uniformity of color. There was no indication of non-uniform draw of the individual microlayers in the plane perpendicular to the moving web. This was later confirmed with photomicrographs of the sample cross section.

Mechanical properties were tested using an Instron model 5500. The force required to break a 6 mm wide strip of post-stretched film exceeded 5 kgf of force in all cases, as compared with less than 2 kgf for the typical non-oriented structure. Apart from the 10-20% of the edge material which remained too thick for color measurement, the primary samples exhibited satisfactory color intensity. The products can be slit into a microfilament thread having a width of about 0.13-0.3 mm.

### EXAMPLE 2

Three film samples were produced with optical cores containing approximately 100 alternating layers. Sample 1 consisted of polybutylene terephthalate and polymethyl methacrylate, sample 2 of polyethylene terephthalate and polymethyl methacrylate, and sample 3 of a copolyester ether and glycol modified polyethylene terephthalate. All samples were between 0.03 and 0.06 mm in thickness. The samples were processed using custom machine direction compression rolling equipment. Effective draw ratios varied from 1.7 to 3.0:1 at mill roll temperatures ranging from 100 to 110 deg C. Mill roll pressures ranged from 1300 psi to 1900 psi. Due to the magnitude and direction of the force vectors deployed, it was anticipated that some degree of thickness gradient would be imparted to the microlayer stack.

By using tension adjustments and draw ratios to control thickness (and thereby color), the thick samples were oriented to predetermine target thickness having peak reflection curves in the 540-600 nm range. There was no evidence of non-uniform draw in the individual microlayers indicated by spectrophotometric readings. This was later confirmed with photomicrographs of the sample cross sections.

Mechanical properties were tested using an Instron model 5500. The force required to break a 6 mm wide strip of post-stretched film exceeded 5 kgf of force. The products can be slit into a microfilament thread having a width of about 0.13-0.3 mm.

Various changes and modifications can be made in the process and products of this invention without departing from the spirit and scope thereof. The various embodiments disclosed herein were for the purpose of illustrating the invention but were not intended to limit it.

What is claimed is:

1. A uniaxial oriented, multilayer co-extruded iridescent film having an ultimate tensile at break of about 2.5 to 9 kgf and a thickness of about 0.007 to 0.034 mm, wherein said film comprises at least 10 very thin layers of substantially uniform thickness, said layers being generally parallel and the contiguous adjacent layers being of different thermoplastic resinous materials whose refractive index differ by at least about 0.03.

2. The uniaxial oriented, multilayer co-extruded iridescent film of claim 1, having an ultimate tensile at break of about 4.5 to 7 kgf.

3. The uniaxial oriented, multilayer co-extruded iridescent film of claim 2, wherein said film comprises at least 35 layers and the contiguous adjacent layers of the film are of different thermoplastic resinous materials whose refractive index differ by at least about 0.06.

4. The uniaxial oriented, multilayer co-extruded iridescent film of claim 3, wherein one of the contiguous adjacent layers of the film is a terephthalate.

5. The uniaxial oriented, multilayer co-extruded iridescent film of claim 6, wherein the one of the contiguous adjacent layers of the film is a thermoplastic elastomer.

6. The uniaxial oriented, multilayer co-extruded iridescent film of claim 1, wherein said film comprises at least 35 layers and the contiguous adjacent layers of the film are of different thermoplastic resinous materials whose refractive index differ by at least about 0.06.

7. The uniaxial oriented, multilayer co-extruded iridescent film of claim 6, wherein one of the contiguous adjacent layers of the film is a terephthalate.

8. The uniaxial oriented, multilayer co-extruded iridescent film of claim 7, wherein the one of the contiguous adjacent layers of the film is a thermoplastic elastomer.

9. The uniaxial oriented, multilayer co-extruded iridescent film of claim 1, in the form a microfilament thread having a width of about 0.15 to 0.3 mm.

10. A method of producing a multilayer co-extruded iridescent film of sufficient strength to be slit into microfilaments which comprises orienting the film while reducing the thickness of the film to about 20% to 50% of the film before compression, wherein said film comprises at least 10 very thin layers of substantially uniform thickness, said layers being generally parallel and the contiguous adjacent layers being of different thermoplastic resinous materials whose refractive index differ by at least about 0.03.

11. The method of claim 10, wherein prior to reduction, the thickness of the film is about 0.035 to 0.065 mm.

12. The method of claim 11, wherein said film comprises at least 35 layers and the contiguous adjacent layers of the film are of different thermoplastic resinous materials whose refractive index differ by at least about 0.06.

13. The method of claim 12, wherein one of the contiguous adjacent layers of the film is a terephthalate.

14. The method of claim 12, wherein the one of the contiguous adjacent layers of the film is a thermoplastic elastomer.

15. The method of claim 12, wherein the film is orientated by being passed between rollers with the aid of a lubricant between the exterior surfaces of the film and the rollers.

16. The method of claim 15, wherein the film is passed between rollers until the thickness of the film is about 33% to 40% of the film before compression.

17. The method of claim 16, wherein subsequent to compression, the film has an ultimate tensile at break of about 2.5 to 9 kgf.

18. The method of claim 17, wherein subsequent to compression, the film has an ultimate tensile at break of about 4.5 to 7 kgf.

19. The method of claim 10, wherein said film comprises at least 35 layers and the contiguous adjacent layers of the film are of different thermoplastic resinous materials whose refractive index differ by at least about 0.06.

20. The method of claim 10, wherein subsequent to compression, the film has an ultimate tensile at break of about 2.5 to 9 kgf.

21. The method of claim 10, wherein subsequent to compression, the film has an ultimate tensile at break of about 4.5 to 7 kgf.

22. The method of claim 10, wherein subsequent to compression, the film is slit into microfilament threads having a width of about 0.15 to 0.3 mm.
